(19) United States
(12) Patent Application Publication
(10) Pub. No.: US 2007/0177946 A1
(43) Pub. Date: Aug. 2, 2007

(54) PIPE REPAIRING SYSTEM

(76) Inventors: Honggie Kim, Santa Fe Springs, CA (US); Russell McFarland, Burbank, CA (US)

Correspondence Address: PARK LAW FIRM, 3255 WILSHIRE BLVD, SUITE 1110, LOS ANGELES, CA, 90010, US

(21) Appl. No.: 11/308,442

(22) Filed: Mar. 24, 2006

Related U.S. Application Data
(60) Provisional application No. 60/764,271, filed on Feb. 1, 2006.

(51) Int. Cl. F16L 55/18

(52) U.S. Cl. 405/184.3; 138/97

(57) ABSTRACT

A system for repairing a pipe damaged with dents includes a pipe holding device, a mandrel, a cable, and a winch. The pipe holding device is for holding the pipe in position. The mandrel, with a cross section and size adapted to be pulled through the interior of the pipe, has a first edge, a second edge, and a side surface. The cable has first and second ends, and the first end is detachably attached to the first edge of the mandrel. The winch is connected to the second end of the cable for winding up the cable. The mandrel is pulled by the winch with the cable and travels through the pipe to push out from inside and remove the dents on the surface of the pipe.

### RELATED APPLICATION

This application is a corresponding non-provisional application of U.S. Provisional Patent Application Ser. No. 60/764,271 for “Method and System for Repairing Metal Pipe” filed on Feb. 1, 2006.

### BACKGROUND OF THE INVENTION

The present invention relates to a system for repairing metal pipe.

More particularly, this invention relates to a system for repairing metal pipe damaged with dents.

Prior to the present invention, all pipe sizes 3″, and under that were damaged were scrapped.

Metal pipes of 4″ and larger were repaired by using a jack system that was very labor intensive. Actually, there are very few repair services available in the pipe industry. The lead time of the major steel service centers to get material repaired was in excess of 4-6 months. During all those long time period the damaged pipe would sit out in the yard rusting to the point that it was no longer considered prime material. This is another reason why many companies would opt to reject in full damaged material.

On all pipe received at the harbor 30% damage is minimum for schedule 10 wall thickness. Lighter walls have in excess of 40% damage.

Insurance companies typically will not insure a product that consistently has more that 10 to 20% damage rate.

Using the present invention, 99% of all damaged material (1¼″ to 6″ nominal) is not able to be repaired in the schedule 10 and under wall thicknesses.

Thousands of feet of pipe can be straightened and have dents removed daily.

Lower insurance premiums will be realized as fewer claims are registered.

Repair cost of 4″ and 6″ pipe are reduced greatly.

1¼″ to 3″ are now repaired and returned to stock and sold as new material.

We will be able to open new profit centers, repairing pipe for companies that import material that suffers damage.

Accordingly, a need for a system for repairing metal pipe has been present for a long time considering the range of pipe use in the modern industrial society. This invention is directed to solve the problems and satisfy the long-felt need.

### SUMMARY OF THE INVENTION

The present invention contrives to solve the disadvantages of the prior art.

An object of the invention is to provide a system for repairing a damaged pipe.

Another object of the invention is to provide a system for repairing a damaged pipe, which can push out the dents and remove the damage from the pipe.

A system for repairing a pipe damaged with dents includes a pipe holding device, a mandrel, a cable, and a winch.

The pipe holding device is for holding the pipe in position.

The mandrel, with a cross section and size adapted to be pulled through the interior of the pipe, has a first edge, a second edge, and a side surface.

The cable has first and second ends, and the first end is detachably attached to the first edge of the mandrel.

The winch is connected to the second end of the cable for winding up the cable.

The mandrel is pulled by the winch with the cable and travels through the pipe to push out from inside and remove the dents on the surface of the pipe.

The pipe holding device includes a processing deck, an overhanging deck, and a pipe stopper.

The processing deck, for supporting the pipe in position, includes a lower beam with first and second ends and a plurality of pipe rests provided on the lower beam.

The overhanging deck, for holding and positioning the pipe, includes an upper beam and a plurality of hydraulic rams extending down from the upper beam.

The pipe stopper is for aligning and stopping the pipe against the force exerted by the mandrel driven by the winch.

The lower beam of the processing deck and the upper beam of the overhanging deck are made of a fabricated I beam. The dimension of the I beam is determined by the dimension of the damaged pipe. The I beam is approximately thirty five (35) feet long, approximately twelve (12) inches wide, and approximately seven (7) inches high.

The pipe rest of the processing deck is substantially V shaped.

The hydraulic ram comprises an arm extending from the upper beam and a pinning hand provided at the end of the arm. The pinning hand is substantially V-shaped.

The pipe stopper includes a bevel surface and a stopping surface, and the bevel surface and the stopping surface are adapted to align and stop the edge of the pipe. The bevel surface and the stopping surface meet each other in approximately from one hundred thirty five (135) to one hundred forty five (145) degrees.

The mandrel includes a tapered head part, a barrel part, and a mechanical fastener.

The tapered head part provided at the first edge, and the diameter is smoothly increasing.

The barrel part, with a diameter accommodating the inner diameter of the pipe, is connected to the tapered head part, provided on the side surface.

The mechanical fastener, for detachably attaching the cable, is provided at the end of the tapered head part.

The mechanical fastener includes a female screw thread.

Alternatively, the mechanical fastener includes a hooking device, in which case the cable includes a looping device adapted to the hooking device.

The winch includes a hydraulic pump. The hydraulic pump is driven by an electrical motor. The hydraulic pump may sense the pressure from the load, and the operation of the electrical motor is controlled by the sensed pressure accordingly.

The system for repairing pipe may further include a feeding rack, a discharge rack, and a slope.

The feeding rack is for feeding the pipes one by one to the processing deck. The discharge rack is for discharging the processed pipes out of the processing deck. The slope, for returning the mandrel, is tilted downward from the finishing end to the starting end.

The system for repairing pipe may further include a lubricant for reducing the friction and wear between the inner surface of the pipe and the side surface of the barrel part of the mandrel.

Alternatively, the mandrel may be driven by a pushing rod instead of the winch and the cable.

The advantages of the present invention are: (1) the system for repairing metal pipe makes it possible to repair metal pipe damaged with dents; and (2) it takes a short time for the system to repair the metal pipe, which enables to handle a truck load of pipes in a reasonable time span.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view of a system for repairing metal pipe according to the present invention;

FIG. 2 is a side plan view of an embodiment of a mandrel according to the present invention;

FIG. 3 is a schematic view showing the relations between a damaged pipe, a mandrel, a cable, and a winch;

FIG. 4 is a cross-sectional view of a pipe rest;

FIG. 5 is a front plan view of a pipe holding device;

FIG. 6 is a front plan view of a pipe stopper;

FIG. 7 is a cross-sectional view of the pipe stopper along the line VII-VII of FIG. 6;

FIG. 8 is a side plan view of another embodiment of a mandrel;

FIG. 9 shows a first end of a cable corresponding mandrel of FIG. 8;

FIG. 10 is a front view of a system according to the present invention with a feeding rack and a discharge rack; and

FIG. 11 is a side view of a system with a slope for returning the mandrel.

### DETAILED DESCRIPTION OF THE INVENTION

The U.S. Provisional Patent Application Ser. No. 60/764,271 by the applicant is incorporated by reference into this disclosure as if fully set forth herein.

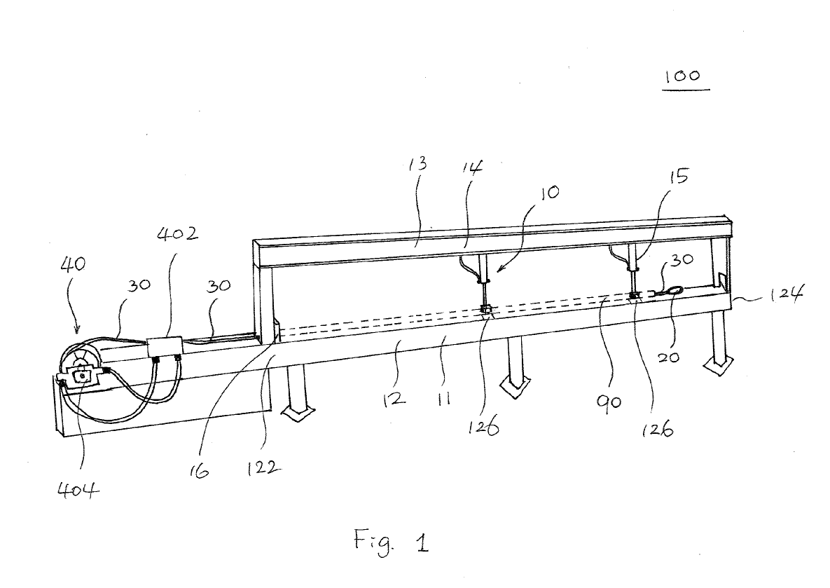

FIG. 1 shows a perspective view of a system 100 for repairing metal pipe 90 according to the present invention

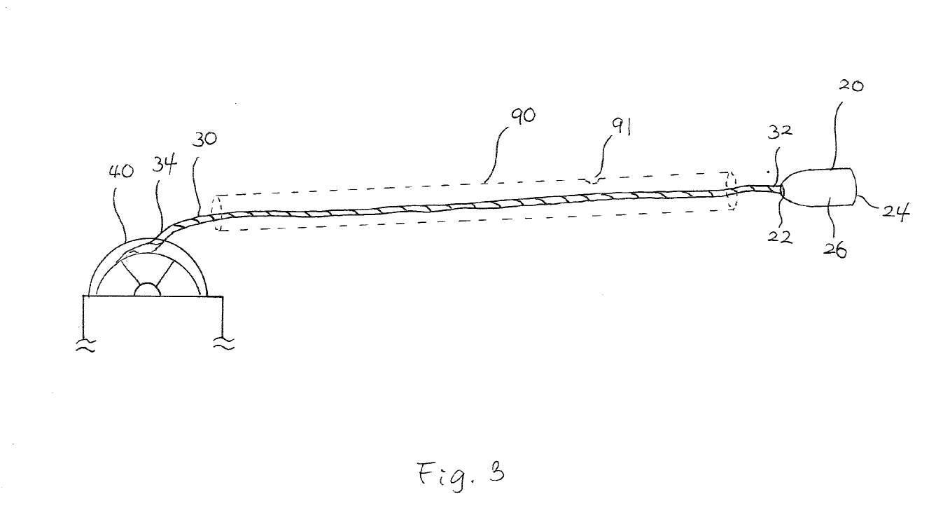

The system 100 for repairing a pipe damaged with dents 91 (refer to FIG. 3) includes a pipe holding device 10, a mandrel 20, a cable 30, and a winch 40.

The pipe holding device 10 is for holding the pipe 90 in position.

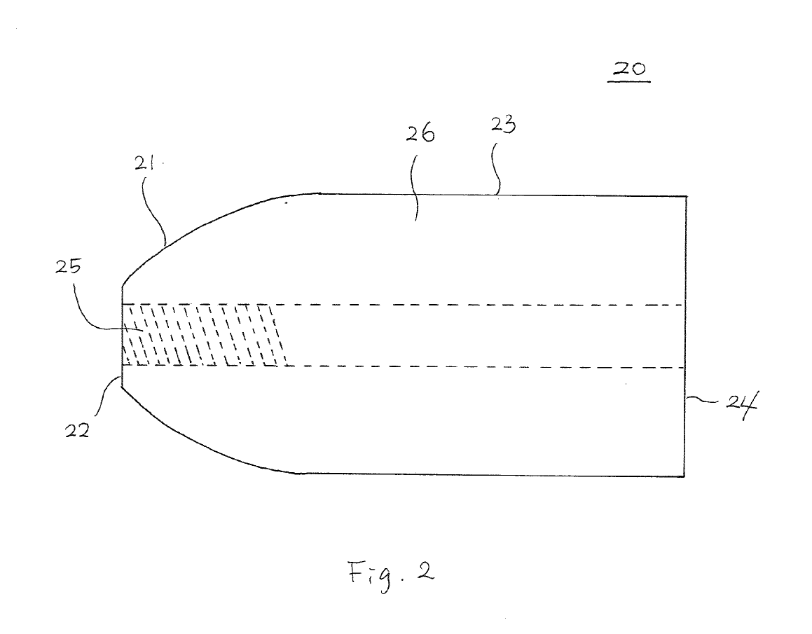

The mandrel 20, with a cross section and size adapted to be pulled through the interior of the pipe 90, has a first edge 22, a second edge 24, and a side surface 26 as shown in FIG. 2.

The cable 30 has first and second ends 32, 34, and the first end 32 is detachably attached to the first edge 22 of the mandrel 20 as shown in FIG. 3.

The winch 40 is connected to the second end 34 of the cable for winding up the cable 30 as shown in FIG. 3.

The mandrel 20 is pulled by the winch 40 with the cable 30 and travels through the pipe 90 to push out from inside and remove the dents 91 on the surface of the pipe 90 as shown in FIG. 3.

The pipe holding device 10 includes a processing deck 12, an overhanging deck 14, and a pipe stopper 16 as shown in FIG. 1.

The processing deck 12, for supporting the pipe 90 in position, includes a lower beam 11 with first and second ends 122, 124 and a plurality of pipe rests 126 provided on the lower beam 11.

The overhanging deck 14, for holding and positioning the pipe 90, includes an upper beam 13 and a plurality of hydraulic rams 15 extending down from the upper beam 13.

The pipe stopper 16 is for aligning and stopping the pipe 90 against the force exerted by the mandrel 20 driven by the winch 40.

The lower beam 11 of the processing deck 12 and the upper beam 13 of the overhanging deck 14 are made of a fabricated I beam. The dimension of the I beam is determined by the dimension of the damaged pipe 90. The I beam is approximately thirty five (35) feet long, approximately twelve (12) inches wide, and approximately seven (7) inches high.

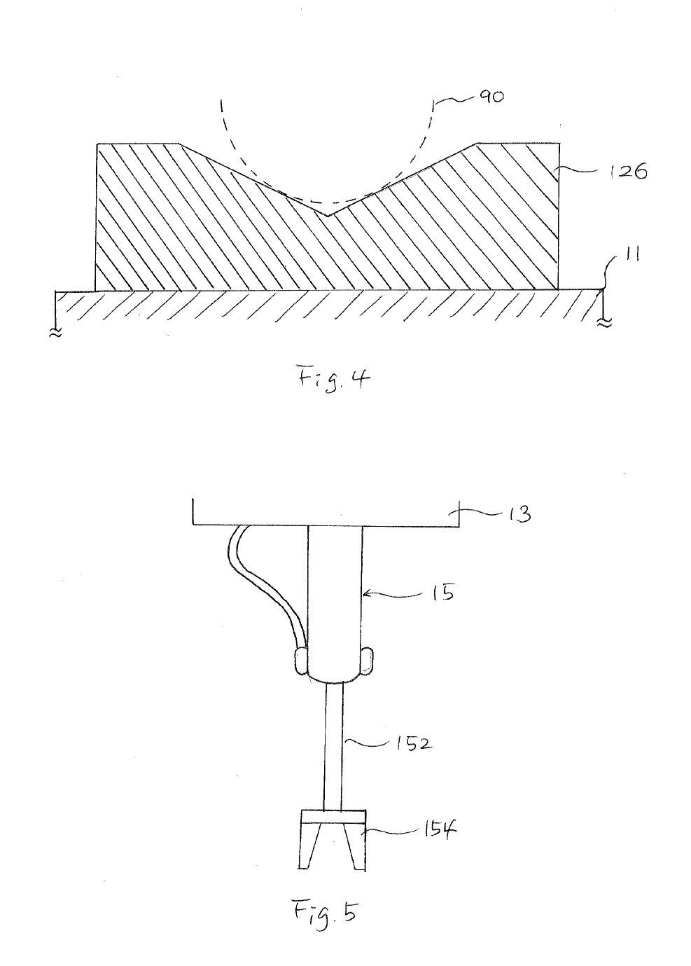

The pipe rest 126 of the processing deck 12 is substantially V shaped as shown in FIG. 4.

The hydraulic ram 15 comprises an arm 152 extending from the upper beam 13 and a pinning hand 154 provided at the end of the arm 152. The pinning hand 154 is substantially V-shaped as shown in FIG. 5.

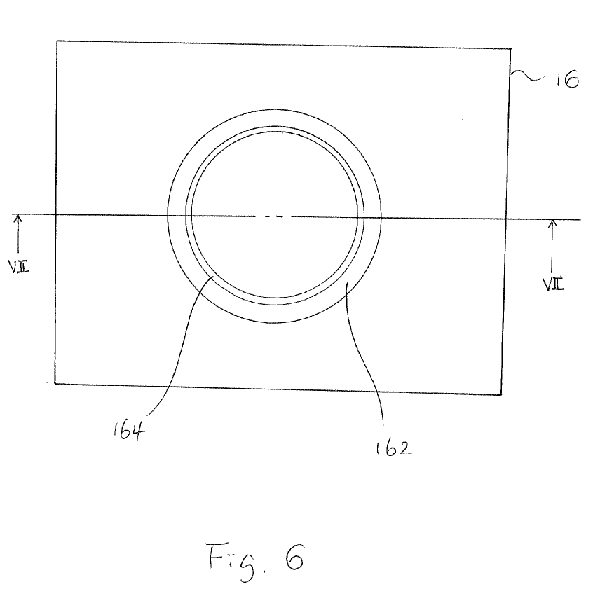

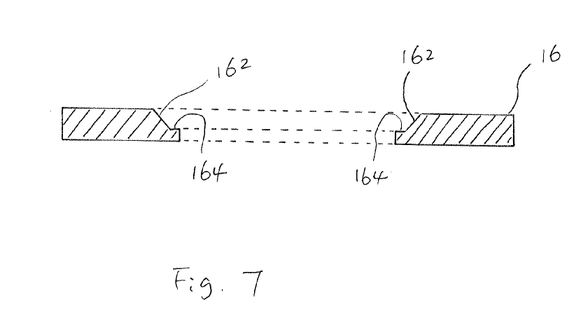

The pipe stopper 16 includes a bevel surface 162 and a stopping surface 164, and the bevel surface 162 and the stopping surface 164 are adapted to align and stop the edge of the pipe 90. The bevel surface 162 and the stopping surface 164 meet each other in approximately from one hundred thirty five (135) to one hundred forty five (145) degrees as shown in FIG. 6 and FIG. 7.

The mandrel 20 includes a tapered head part 21, a barrel part 23, and a mechanical fastener 25.

The tapered head part 21 provided at the first edge 22, and the diameter is smoothly increasing.

The barrel part 23, with a diameter accommodating the inner diameter of the pipe 90, is connected to the tapered head part 21, provided on the side surface 26.

The mechanical fastener 25, for detachably attaching the cable 30, is provided at the end of the tapered head part 21.

The mechanical fastener 25 includes a female screw thread as shown in FIG. 2.

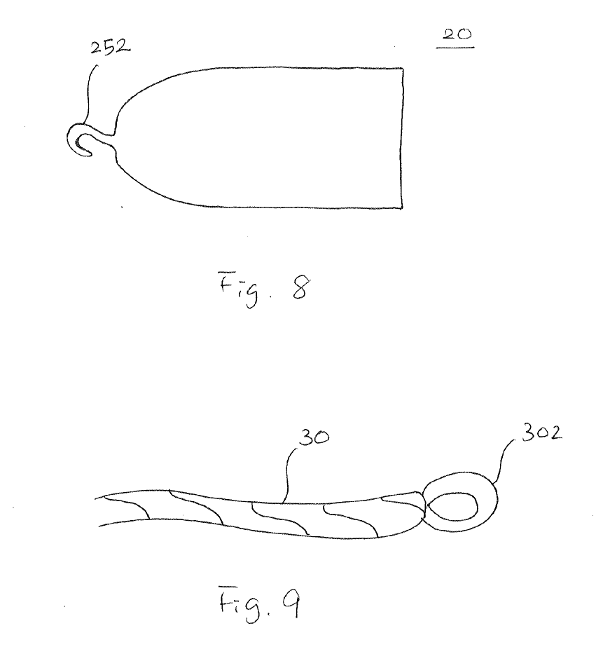

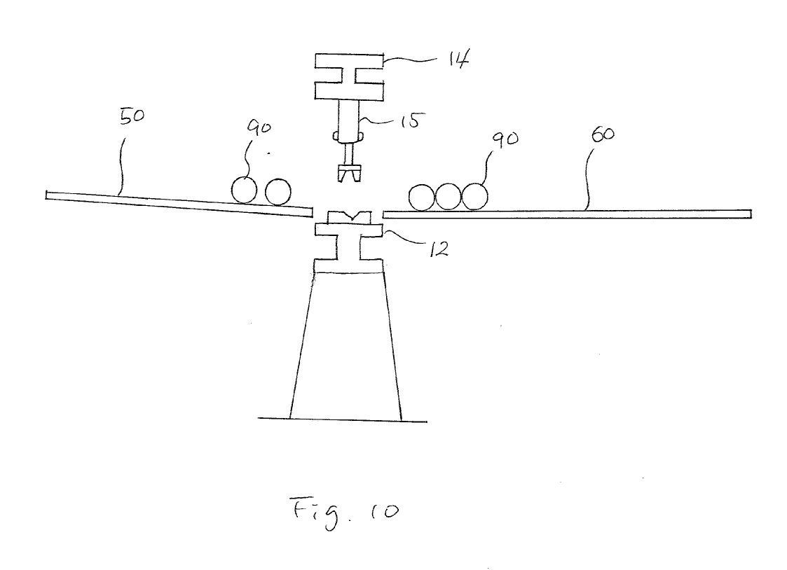

Alternatively, the mechanical fastener 25 includes a hooking device 252, in which case the cable 30 includes a looping device 302 adapted to the hooking device 252 as shown in FIG. 8 and FIG. 9.

The winch 40 includes a hydraulic pump 402. The hydraulic pump 402 is driven by an electrical motor 404. The hydraulic pump 402 may sense the pressure from the load, and the operation of the electrical motor 404 is controlled by the sensed pressure accordingly.

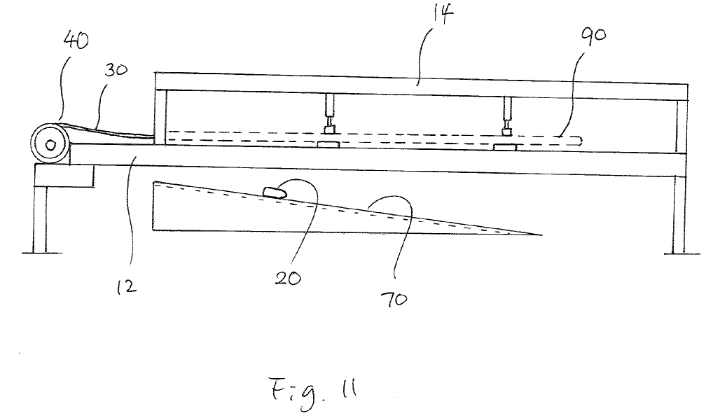

The system 100 for repairing pipe may further include a feeding rack 50, a discharge rack 60, and a slope 70 as shown in FIG. 10.

The feeding rack 50 is for feeding the pipes 90 one by one to the processing deck 12. The discharge rack 60 is for discharging the processed pipes 90 out of the processing deck 12. The slope 70, for returning the mandrel 20, is tilted downward from the finishing end to the starting end as shown in FIG. 11. The mandrel 20 must be detached from the cable 30 and then brought to the finishing end, the far side from the winch 40 after the travel through the pipe 90 in order to be attached to the cable queued through next damaged pipe 90.

The system for repairing pipe may further include a lubricant for reducing the friction and wear between the inner surface of the pipe and the side surface of the barrel part of the mandrel.

Alternatively, the mandrel 20 may be driven by a pushing rod (not shown) instead of the winch 40 and the cable 30.

In an embodiment of the system according to the present invention, the system specifications may include the followings:

Hydraulically driven by a 60 gallon per minute, 2500 psi, variable pump, pressure compensated.

Electric motor to run the hydraulics is 50 hp, 440 three phase.

Winch will pull up #12,000 of horizontal force and capable of 135 feet per minute.

Mandrels are machined out of 1080 shaft steel and carbonized for hardening.

Main winch drive in manually controlled and pipe hold down clamps are actuated by electric controls.

The mandrel connected to the end of the wire cable is driven through the damaged pipe for repairing or pushing out the dents. The mandrel travels from the first end the pipe to the second end of the pipe, and must be brought back to the first end of a new pipe to repair. Actually, the mandrel is very heavy. Therefore, the system may further include a tilted slope, provided just by the rack, with a greased rail for sliding the mandrel from the second end to the first end using the universal gravity.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A system for repairing a pipe damaged with dents comprising:
a) a pipe holding device for holding the pipe in position;
b) a mandrel, with a cross section and size adapted to be pulled through the interior of the pipe, having a first edge, a second edge, and a side surface;
c) a cable having first and second ends, wherein the first end is detachably attached to the first edge of the mandrel; and
d) a winch connected to the second end of the cable for winding up the cable,
wherein the mandrel is pulled by the winch with the cable, wherein the mandrel travels through the pipe to push out from inside and remove the dents on the surface of the pipe.

2. The system of claim 1, wherein the pipe holding device comprises:
a) a processing deck, for supporting the pipe in position, comprising a lower beam with first and second ends and a plurality of pipe rests provided on the lower beam;
b) an overhanging deck, for holding and positioning the pipe, comprising an upper beam and a plurality of hydraulic rams extending down from the upper beam; and
c) a pipe stopper for aligning and stopping the pipe against the force exerted by the mandrel driven by the winch.

3. The system of claim 2, wherein the lower beam of the processing deck and the upper beam of the overhanging deck are made of a fabricated I beam.

4. The system of claim 3, wherein the dimension of the I beam is determined by the dimension of the damaged pipe.

5. The system of claim 4, wherein the I beam is approximately thirty five (35) feet long, approximately twelve (12) inches wide, and approximately seven (7) inches high.

6. The system of claim 2, wherein the pipe rest of the processing deck is substantially V shaped.

7. The system of claim 2, wherein the hydraulic ram comprises an arm extending from the upper beam and a pinning hand provided at the end of the arm.

8. The system of claim 7, wherein the pinning hand is substantially V-shaped.

9. The system of claim 2, wherein the pipe stopper comprises a bevel surface and a stopping surface, wherein the bevel surface and the stopping surface are adapted to align and stop the edge of the pipe.

10. The system of claim 9, wherein the bevel surface and the stopping surface meet each other in approximately from one hundred thirty five (135) to one hundred forty five (145) degrees.

11. The system of claim 1, wherein the mandrel comprises:
a) a tapered head part provided at the first edge, wherein the diameter is smoothly increasing;
b) a barrel part, with a diameter accommodating the inner diameter of the pipe, connected to the tapered head part, provided on the side surface; and
c) a mechanical fastener, for detachably attaching the cable, provided at the end of the tapered head part.

12. The system of claim 11, wherein the mechanical fastener comprises a female screw thread.

13. The system of claim 11, wherein the mechanical fastener comprises a hooking device.

14. The system of claim 13, wherein the cable comprises a looping device adapted to the hooking device.

15. The system of claim 1, wherein the winch comprises a hydraulic pump.

16. The system of claim 15, wherein the hydraulic pump is driven by an electrical motor.

17. The system of claim 16, wherein the hydraulic pump senses the pressure from the load, wherein the operation of the electrical motor is controlled by the sensed pressure.

18. The system of claim 1, further comprising:
a) a feeding rack for feeding the pipes one by one to the processing deck;
b) a discharge rack for discharging the processed pipes out of the processing deck; and
c) a slope, for returning the mandrel, tilting downward from the finishing end to the starting end.

19. The system of claim 1, further comprising a lubricant for reducing the friction and wear between the inner surface of the pipe and the side surface of the barrel part of the mandrel.

20. A system for repairing a pipe damaged with dents comprising:
a) a pipe holding device for holding the pipe in position;
b) a mandrel, with a cross section and size adapted to be pulled through the interior of the pipe, having a first edge, a second edge, and a side surface; and
c) a pushing rod for pushing the mandrel through the pipe,
wherein the mandrel travels through the pipe to push out from inside and remove the dents on the surface of the pipe.
